(19) United States
(12) Patent Application Publication
(10) Pub. No.: US 2016/0185383 A1
(43) Pub. Date: Jun. 30, 2016

(54) ACTUATOR AND VEHICLE STEERING APPARATUS

(71) Applicant: SHOWA CORPORATION, Gyoda-shi (JP)

(72) Inventors: Hiroshi FUJITA, Haga-gun (JP); Akira FUJISAKI, Haga-gun (JP)

(73) Assignee: SHOWA CORPORATION, Gyoda-shi (JP)

(21) Appl. No.: 14/721,998

(22) Filed: May 26, 2015

(30) Foreign Application Priority Data
Dec. 25, 2014 (JP) 2014-262718

(51) Int. Cl. B62D 5/04; B62D 3/06

(52) U.S. Cl. CPC B62D 5/0421; B62D 3/06; B62D 5/0454; B62D 5/046

(57) ABSTRACT

An actuator includes a motor, a reverse input prevention device, a conversion device, and a rod. The reverse input prevention device includes an input member and an output member. The reverse input prevention device prevents an external force inputted to the output member from being transmitted to the input member. The output member has a lock portion, an outer peripheral wall portion, pairs of pins, elastic bodies arranged between the pairs of pins and biasing the pairs of pins so as to be apart from one another in a circumferential direction, and the input member including plural hooks arranged on both sides of the pairs of pins in a circumferential direction. After the rod reaches a target position by one-direction rotation of the rotation shaft, the plural hooks return to an initial position by the other-direction rotation of the rotation shaft.

### CROSS-REFERENCE TO RELATED APPLICATIONS

This application is based on and claims priority under 35 USC 119 from Japanese Patent Application No. 2014-262718 filed on Dec. 25, 2014, the entire content of which is incorporated herein by reference.

### BACKGROUND

1. Technical Field

The present invention relates to an actuator and a vehicle steering apparatus for a vehicle.

2. Related Art

In four-wheeled vehicles in recent years, a vehicle steering apparatus for rear wheels is provided in many cases for controlling a steering angle of rear wheels to a desired angle in accordance with travelling conditions.

As the steering apparatus for the vehicle, there exist a right and left integral type apparatus in which right and left wheels are steered together by one actuator and a right and left independent type apparatus in which right and left wheels are independently steered by providing actuators at right and left respectively.

The actuator used for the right and left independent type steering apparatus for vehicle generally includes a rod advanced/retracted freely in an axial direction, a motor including a rotation shaft, a worm gear and a worm wheel reducing the rotation speed of the rotation shaft and a conversion device (a ball screw or a feed screw) converting a rotational motion of the worm wheel into a linear motion of the rod to allow the rod to be advanced and retracted (refer to JP-A-2009-243621 (Patent Document 1)).

In actuators described in JP-A-2003-237614 (Patent Document 2) and JP-A-2003-81106 (Patent Document 3), a reverse input prevention device is provided on a transmission path for the drive force of the motor, which prevents transmission of the inputted external force to the motor side.

### SUMMARY OF THE INVENTION

An illustrative aspect of the present invention is to provide an actuator and a steering apparatus for a vehicle capable of preventing backlash of the rod occurring after reaching the target position.

According to an embodiment of the present invention, there is provided an actuator including a motor including a rotation shaft, a reverse input prevention device including an input member which is rotated by rotation of the rotation shaft and an output member which is rotated by rotation of the input member, preventing an external force inputted to the output member from being transmitted to the input member, a conversion device that converts a rotational motion of the output member into a linear motion, and a rod advancing/retracting by the linear motion of the conversion device, in which the reverse input prevention device includes the output member having a lock portion in which plural flat surfaces are formed on an outer peripheral surface, an outer peripheral wall portion in which an approximately circular inner peripheral surface surrounding an outer periphery of the lock portion is formed, pairs of pins arranged between the respective flat surfaces and the inner peripheral surface, elastic bodies arranged between the pairs of pins and each biasing a corresponding one of the pairs of pins so that the pins of the corresponding pair are apart from one another in a circumferential direction, and the input member including plural hooks arranged on both sides of the pairs of pins in the circumferential direction, and, after the rod reaches a target position by one-direction rotation of the rotation shaft, the plural hooks return to an initial position relative to the pairs of pins by the other-direction rotation of the rotation shaft.

Also according to the embodiment of the present invention, there is provided a vehicle steering apparatus including an actuator including an advancing/retracting rod, which steers vehicle wheels by advancing/retracting the rod, in which the actuator includes a motor including a rotation shaft, a reverse input prevention device including an input member which is rotated by rotation of the rotation shaft and an output member which is rotated by rotation of the input member, preventing an external force inputted to the output member from being transmitted to the input member, a conversion device that converts a rotational motion of the output member into a linear motion, and the rod advancing/retracting by the linear motion of the conversion device, the reverse input prevention device includes the output member having a lock portion in which plural flat surfaces are formed on an outer peripheral surface, an outer peripheral wall portion in which an approximately circular inner peripheral surface surrounding an outer periphery of the lock portion is formed, pairs of pins arranged between the respective flat surfaces and the inner peripheral surface, elastic bodies arranged between the pairs of pins and each biasing a corresponding one of the pairs of pins so that the pins of the corresponding pair are apart from one another in a circumferential direction, and the input member including plural hooks arranged on both sides of the pairs of pins in the circumferential direction, and, after the rod reaches a target position by one-direction rotation of the rotation shaft, the plural hooks return to an initial position relative to the pairs of pins by the other-direction rotation of the rotation shaft.

According to the embodiment of the present invention, after the rod reaches the target position, the rotation shaft is rotated in the other direction and the hooks of the input member return to the initial position. Accordingly, the rod is locked (immovable) and backlash in the rod can be prevented.

### BRIEF DESCRIPTION OF THE DRAWINGS

FIG. 1 is a rear view of a suspension of a left rear wheel of a four-wheeled vehicle seen from the rear;

FIG. 2 is a cross-sectional view taken along II-II line of FIG. 3;

FIG. 3 is a cross-sectional view of an actuator;

FIG. 4 is an enlarged view of a range surrounded by a frame line C of FIG. 3;

FIG. 5 is a cross-sectional view taken along V-V line of FIG. 3;

FIG. 6 is a cross-sectional view taken along VI-VI line of FIG. 3;

FIG. 7 is an exploded perspective view of parts assembled to an outer peripheral side of an output member and a nut;

FIG. 8A is an enlarged view of a range surrounded by a frame line D of FIG. 6 in a disabled state of rotation of an output member, FIG. 8B is an enlarged view of a range surrounded by the frame line D of FIG. 6 in a state where a clockwise rotation of the output member is cancelled, FIG. 8C is an enlarged view of a range surrounded by the frame line D of FIG. 6 in a state where a disabled state of a counterclockwise rotation of the output member is maintained when the output member is rotated and FIG. 8D is an enlarged view of a range surrounded by the frame line D of FIG. 6 in a state where an input shaft is reversed after the rod reaches a target position;

FIG. 9A is a view showing a state before a rotation shaft of the motor rotates in one direction and a corresponding enlarged view of a range surrounded by a frame line E of FIG. 2, FIG. 9B is a view showing a state where a rotation angle of the rotation shaft of the motor is θ5 and a corresponding enlarged view of a range surrounded by the frame line E of FIG. 2, FIG. 9C is a view showing a state where the rotation angle of the rotation shaft of the motor by one-direction rotation is θ6 and a corresponding enlarged view of a range surrounded by the frame line E of FIG. 2, and FIG. 9D is a view showing a state where the rotation angle of the rotation shaft of the motor by the other direction rotation is θ5 and a corresponding enlarged view of a range surrounded by the frame line E of FIG. 2;

FIG. 10 is a flow chart showing a process of steering-angle change processing by a controller;

FIG. 11 is a correlation chart showing the relation between a moving distance of the rod and the rotation angle of the rotation shaft of the motor contributed to the movement of the rod; and

FIG. 12 is a view showing rotation angles of the input member in the steering angle change processing.

### DETAILED DESCRIPTION OF THE INVENTION

An embodiment of the present invention will be explained with reference to the drawings accordingly. In explanation of the embodiment, an example in which the present invention is applied to a steering apparatus for a vehicle which steers rear wheels of a four-wheeled vehicle is cited.

The four-wheeled vehicle is an FF (Front-engine Front-drive) based four-wheel drive vehicle.

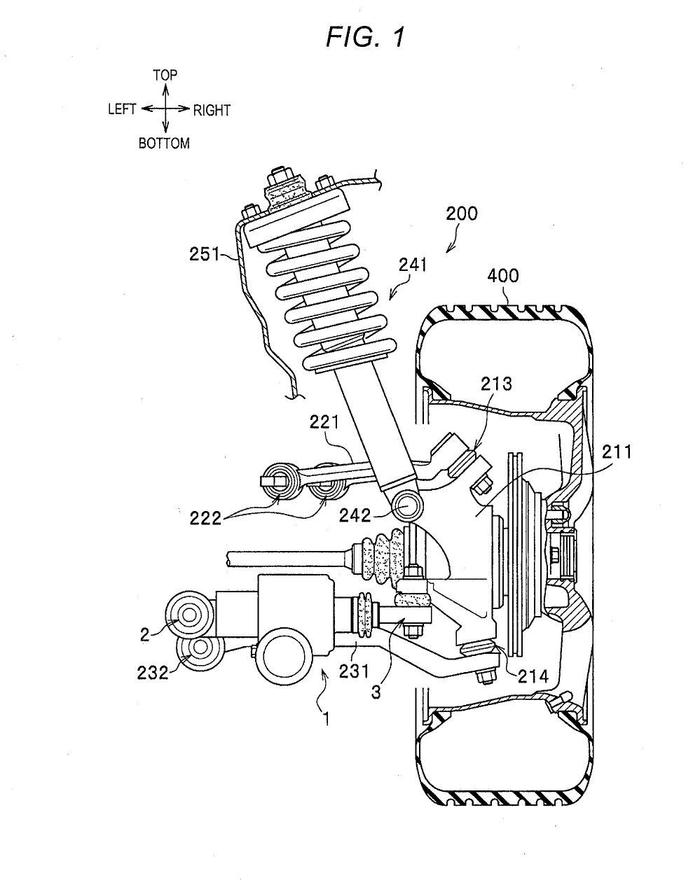

As shown in FIG. 1, a rear wheel 400 of the four wheeled vehicle is suspended by a suspension 200 belonging to a double wishbone type.

The suspension 200 includes a knuckle 211 supporting the rear wheel 400 so as to rotate, an upper arm 221 and a lower arm 231 connecting the knuckle 211 to a vehicle body so as to vertically move, a damper 241 with a suspension spring absorbing the vertical movement of the rear wheel 400, an actuator 1 changing a steering angle of the rear wheel 400 by allowing the knuckle 211 to rotationally move and a controller (not shown) controlling the actuator 1.

An upper part of the knuckle 211 is connected to a tip portion of the upper arm 221 through a ball joint 213 so as to pivotally move. A lower part of the knuckle 211 is connected to a tip portion of the lower arm 231 through a ball joint 214 so as to pivotally move. Then, the knuckle 211 rotationally moves around the ball joints 213 and 214, thereby changing the steering angle of the rear wheel 400.

A base portion of the upper arm 221 is attached to the vehicle body through two bushes 222, 222 so as to rotationally move. A base portion of the lower arm 231 is attached to the vehicle body through two bushes 232 (only one is shown in FIG. 1) so as to pivotally move. As the upper arm 221 and the lower arm 231 rotationally move around the base portion side, the rear wheel 400 vertically moves.

The damper 241 is a hydraulic damper (hydraulic shock absorber) with a spring. An upper part of the damper 241 is fixed to a vehicle body 251. A lower part of the damper 241 is connected to the knuckle 211 through a bush 242.

An end portion on an inner side of the actuator 1 in a vehicle width direction is connected to the vehicle body through a bush 2. On the other hand, an end portion on an outer side of the actuator 1 in the vehicle width direction is connected to the knuckle 211 through a bush 3. Accordingly, the actuator 1 is interposed between the vehicle body and the knuckle 211.

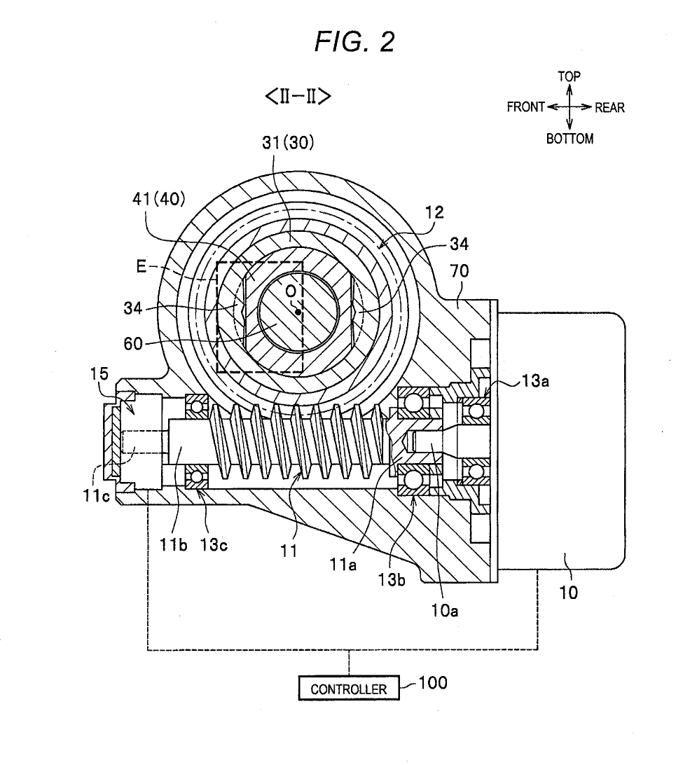

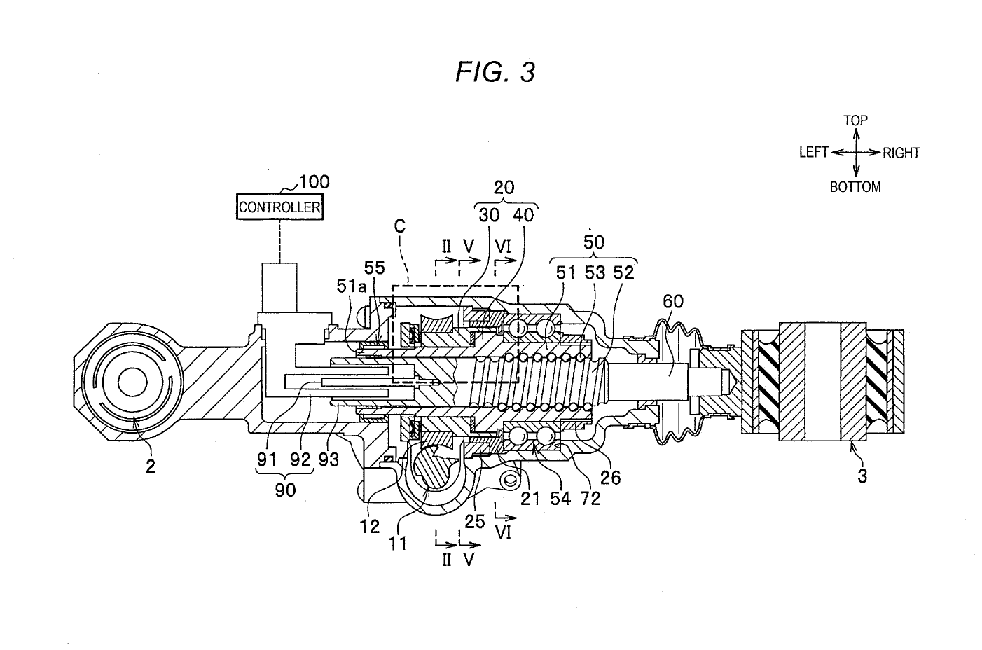

As shown in FIG. 2 and FIG. 3, the actuator 1 includes a motor 10 including a rotation shaft 10a, a worm gear 11 connecting to the rotation shaft 10a, an angle sensor 15 connected to the worm gear 11 and measuring a rotation angle of the rotation shaft 10a, a worm wheel 12 engaged with the worm gear 11, a reverse input prevention device 20 including an input member 30 and an output member 40 to be rotated with the rotation of the worm wheel 12, a conversion device 50 including a nut 51 rotating with the rotation of the output member 40, a rod 60, a stroke sensor 90 and a controller 100.

As shown in FIG. 2, the motor 10 is a device generating a drive force for advancing/retracting the rod 60, in which the rotation shaft 10a rotates by receiving a control signal from the controller 100.

The motor 10 is fixed to a housing 70 so that the rotation shaft 10a is directed to the front. The rotation shaft 10a of the motor 10 is rotatably supported by a ball bearing 13a provided in the housing 70.

The worm gear 11 and the worm wheel 12 are provided for reducing the speed of the rotational motion of the rotation shaft 10a.

The rotation shaft 10a of the motor 10 is fitted to a base portion 11a of the worm gear 11, and the rotation shaft 10a and the worm gear 11 rotate integrally. The base portion 11a and a tip end 11b of the worm gear 11 are rotatably supported by ball bearings 13b and 13c, which makes the rotation axis of the worm gear 11 hard to be eccentric.

A columnar shaft 11c projecting to the front is formed in the tip end 11b of the worm gear 11, and the shaft 11c enters into the angle sensor 15.

The angle sensor 15 is a sensor measuring a rotation angle of the rotation shaft 10a of the motor 10 integrally rotating with the worm gear 11 through the rotation angle of the shaft 11c of the worm gear 11 and transmitting a measured result to the controller 100. As the angle sensor 15, a rotary encoder, a resolver or the like can be cited, however, the type of the angle sensor 15 is not particularly limited in the present invention.

When the controller 100 provides an instruction to the motor 10 by designating the rotation angle of the rotation shaft 10a, the actual rotation angle of the rotation shaft 10a may be smaller than the designated rotation angle as the rotation shaft 10a receives friction of the bearing 13a and so on. Accordingly, it is possible to clearly grasp the rotation angle 10a of the motor 10 as the angle sensor 15 is provided in the present embodiment.

The worm wheel 12 has a tubular shape, in which the tubular input member 30 is arranged inside the worm wheel 12. The tubular output member 40 pivotally supporting the input member 30 is also provided inside the input member 30.

The input member 30 is a member for transmitting the drive force of the motor 10 transmitted from the worm wheel 12 to the output member 30.

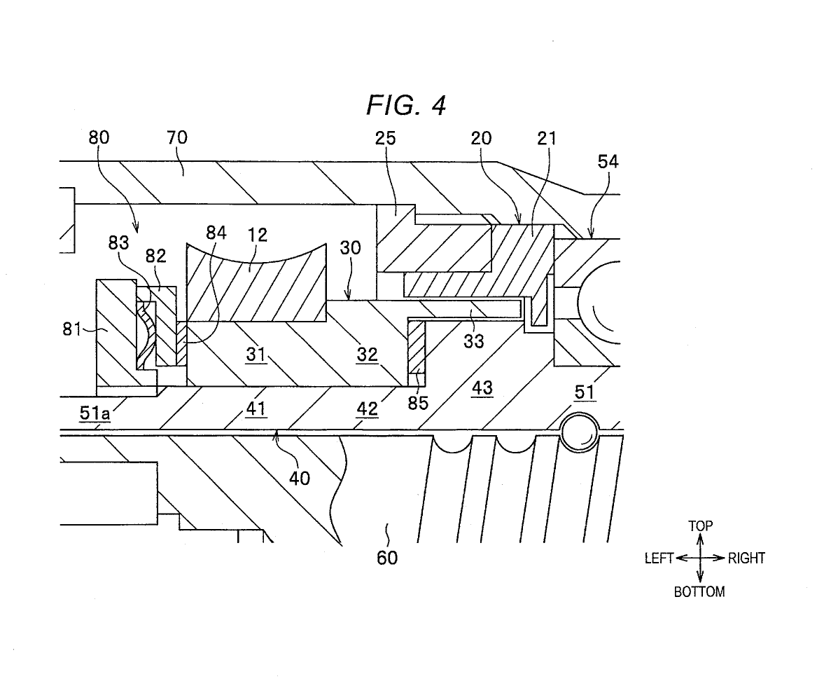

As shown in FIG. 4, the input member 30 includes an approximately cylindrical fixing portion 31 fitted into the worm wheel 12, a cylindrical portion 32 provided on an outer side of the vehicle width direction from the fixing portion 31, plural hooks 33 extending from the cylindrical portion 32 to the outer side of the vehicle width direction and transmission portions 34, 34 (see FIG. 2) projecting from an inner peripheral surface of the fixing portion 31 to the inner side of the radial direction.

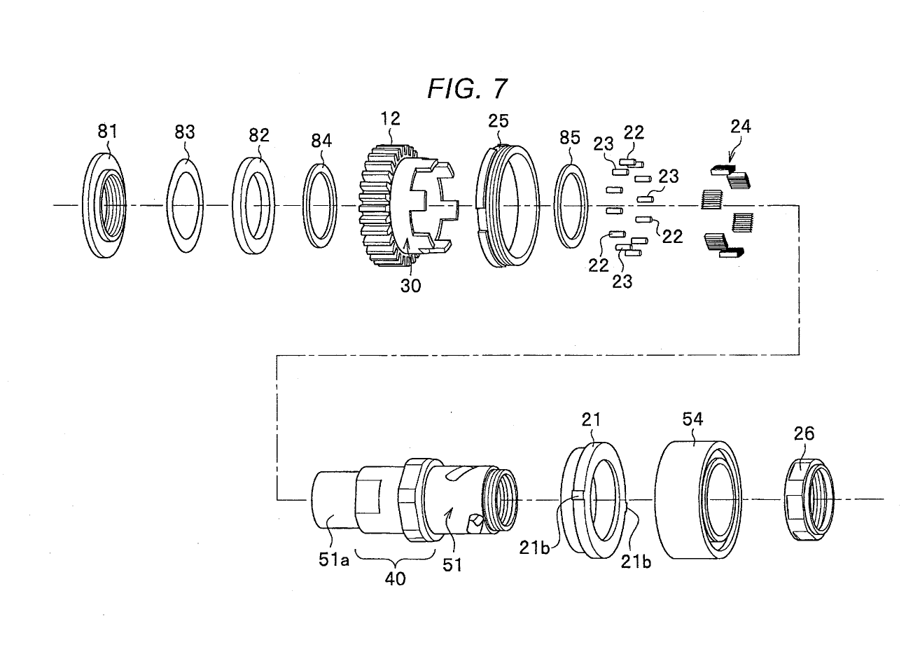

The fixing portion 31 is fitted into the worm wheel 12 before the assembly of the actuator 1, and the input member 30 is integrally formed with the worm wheel 12 (see FIG. 7). Accordingly, the input member 30 and the worm gear 11 can be assembled as one part at the time of manufacturing the actuator 1. Additionally, after the assembly, the worm wheel 12 and the input member 30 integrally rotate when the worm gear 11 rotates.

The output member 40 is a member for transmitting the drive force of the motor 10 transmitted from the input member 30 to the nut 51 of the conversion device 50.

As shown in FIG. 4, the output member 40 includes a transmitted portion 41 positioned inside the fixing portion 31 of the input member 30, a shaft support portion 42 positioned on the inner side of the cylindrical portion 32 and supporting the cylindrical portion 32 and a lock portion 43 provided on the outer side of the shaft support portion 42 in the vehicle width direction.

The nut 51 in which spiral grooves are formed on an inner peripheral side is provided on the outer side of the lock portion 43 of the output member 40 in the vehicle width direction. On the other hand, an approximately cylindrical extending portion 51a forming part of the nut 51 is provided on the inner side of the transmitted portion 41 of the output member 40 in the vehicle width direction.

The nut 51 (including the extending portion 51a) and the output member 40 are formed by cutting one SUS material or the like (see FIG. 7). As the output member 40 and the nut 51 are integrally formed, the output member 40 and the nut 51 integrally rotate when the drive force of the motor 10 is transmitted from the input member 30.

Each constitution of the input member 30 and the output member 40 will be described in detail later.

As shown in FIG. 3, the conversion device 50 is a device for converting the rotational motion of the nut 51 into the linear motion, which is formed of a ball screw in the present embodiment.

The conversion device 50 of the present embodiment includes the approximately cylindrical nut 51 in which spiral grooves are formed on the inner peripheral surface, an approximately columnar screw shaft 52 in which spiral grooves are formed on an outer peripheral surface and plural balls 53 housed both in the spiral grooves of the nut 51 and the spiral grooves of the screw shaft 52.

The nut 51 is fitted to an inner ring of a ball bearing 54 fitted into the housing 70. The extending portion 51a included in the nut 51 is fitted into a roller bearing 55 fitted into the housing 70. Accordingly, both ends of the nut 51 are rotatably supported by the ball bearing 54 and the roller bearing 55, and the nut 51 and the output member 40 are rotatably fixed inside the housing 70.

A lock nut 26 (see FIG. 7) is screwed onto an outer peripheral surface on the outer side of the nut 51 in the vehicle width direction.

The lock nut 26 abuts on the inner ring of the ball bearing 54 from the outer side of the vehicle width direction, thereby regulating the nut 51 so as not to be displaced to the inner side of the vehicle width direction.

Furthermore, a step portion 72 of the housing 70 abuts on an outer ring of the ball bearing 54, thereby regulating the ball bearing 54 so as not to move to the outer side of the vehicle width direction.

The screw shaft 52 is integrally formed with a rod 60 arranged on the outer side of the vehicle width direction. Then, when the screw shaft 52 moves to the outer side or the inner side of the vehicle width direction by the rotation of the nut 51, a projection amount of the rod 60 projecting from the housing 70 is changed.

In the embodiment, when the projecting amount of the rod 60 is increased, the rear wheel 400 rotates in the toe-in side. On the other hand, when the projecting amount of the rod 60 is reduced, the expansion/contraction actuator 1 contracts and the rear wheel 400 rotationally moves in the toe-out side.

A bottomed tubular portion 93 having a bottomed tubular shape which opens toward the inner side of the vehicle width direction is formed on the inner side of the screw shaft 52 in the vehicle width direction.

A later-described detected portion 91 and a detection portion 92 of the stroke sensor 90 are housed inside the bottomed tubular portion 93, which narrows a space occupied by the stroke sensor 90 inside the housing 70.

The reverse input prevention device 20 is a device for preventing an external force inputted to the output member 40 through the rod 60 from being transmitted to the input member 30.

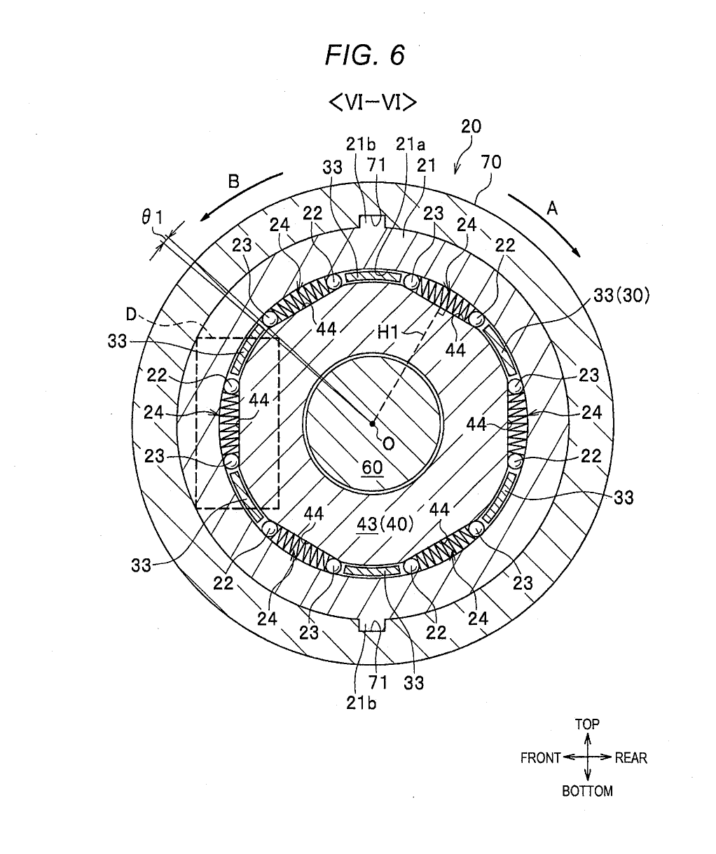

As shown in FIG. 6, the reverse input prevention device 20 includes the output member 40 including the lock portion 43 on which flat surfaces 44 are formed, an outer case (outer peripheral wall portion) 21 in which an approximately circular inner peripheral surface 21a surrounding the outer periphery of the lock portion 43 is formed, pairs of pins 22 and 23 arranged between respective flat surfaces 44 and the inner peripheral surface 21a, elastic bodies 24 arranged between pairs of pins 22 and 23 and biasing respective pairs of pins 22 and 23 so as to be apart from one another in a circumferential direction, the input member 30 including plural hooks 33 arranged on both sides of the pairs of pins 22 and 23 in the circumferential direction and an attachment portion 80 (see FIG. 4).

Hereinafter, the case seen from the inner side to the outer side of the vehicle width direction concerning the rotation direction (rotary movement direction) will be explained as a reference. Accordingly, a “clockwise direction” means a direction directed by an arrow A in FIG. 6 and a “counterclockwise direction” means a direction directed by an arrow B in FIG. 6.

The outer case 21 is an approximately cylindrical member (see FIG. 7). Two projections 21b projecting from the outer peripheral surface to the outer side of the radial direction are formed in the outer case 21. The projections 21b are fitted to concave portions 71 formed in the housing 70, which prevents the outer case 21 from rotationally moving with respect to the housing 70 in the circumferential direction.

Additionally, as shown in FIG. 4, a fixed screw 25 screwed to the housing 70 is arranged on the inner side of the outer case 21 in the vehicle width direction. Then, the outer case 21 is screwed to the outer side of the vehicle width direction by the fixed screw 25.

Accordingly, as shown in FIG. 3, the outer case 21 and the ball bearing 54 adjacent to the outer case 21 are sandwiched by the fixed screw 25 and the step portion 72 of the housing 70, which are fixed to the housing 70 so as not to move in the vehicle width direction.

As shown in FIG. 6, plural flat surfaces 44 are formed on the outer peripheral surface of the lock portion 43 at intervals of approximately 60 degrees. Though the flat surfaces 44 are formed at intervals of approximately 60 degrees in the embodiment, the present invention is not limited to this.

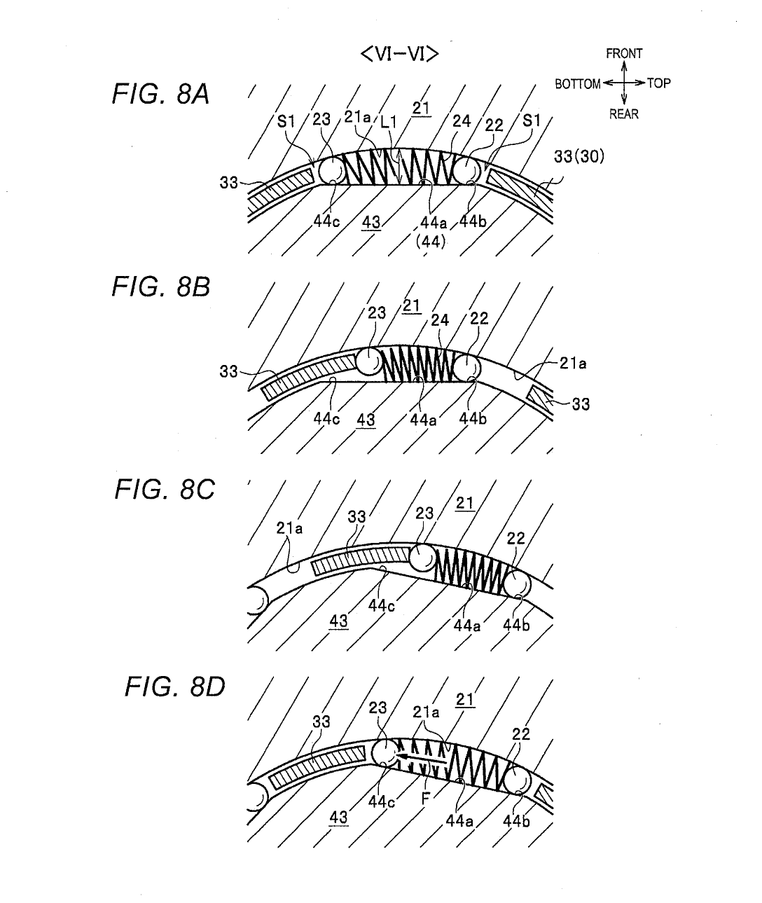

Each flat surface 44 is orthogonal to a straight line H1 passing through the central axis O of the rod 60. Accordingly, a width L1 between the flat surface 44 and the inner peripheral surface 21a of the outer case 21 becomes narrow from a central portion 44a toward a right end portion 44b side and a left end portion 44c side in the flat surface 44 as shown in FIG. 8A. Each of the pair of pins 22 and 23 is a cylindrical member (see FIG. 7).

As shown in FIGS. 8A to 8D, the pin arranged in the clockwise direction with respect to the elastic body 24 is referred to as a right-side pin 22 and the pin arranged in the counterclockwise direction is referred to as a left-side pin 23 in the pair of pins 22 and 23.

The elastic body 24 is a bellow-like flat spring (see FIG. 7), which is provided between the pair of pins 22 and 23 in a contracted state in the circumferential direction. Accordingly, each of the pair of pins 22 and 23 which is constantly biased by the elastic body 24 so as to be apart from each other in the circumferential direction is sandwiched between the right end portion 44b of the flat surface 44 and the inner peripheral surface 21a or between the left end portion 44c and the inner peripheral surface 21a, the width of which is narrowed, therefore, it is difficult that the output member 40 rotates with respect to the outer case 21 (housing 70).

As a result, the output member 40 does not rotate even when the external force is inputted to the rod 60, therefore, the external force is not transmitted from the output member 40 to the input member 30.

Each of the hooks 33 is formed in an arc shape as shown in FIG. 6. The plural hooks 33 are provided at intervals of approximately 60 degrees and are provided in a manner of being shifted in the circumferential direction so as not to face the flat surfaces 44 of the output member 40 when the drive force of the motor 10 is not transmitted to the input member 30.

Accordingly, the left-side pins 23 sandwiched between the outer case 21 and the left end portions 44c of the flat surface 44 are arranged in the clockwise direction of the hooks 33, and the right-side pins 22 sandwiched between the outer case 21 and the right end portions 44b of the flat surface 44 are arranged in the counterclockwise direction of the hooks 33.

Hereinafter, a space between the left-side pin 23 in a state of being arranged in the clockwise direction of the hook 33 and sandwiched between the outer case 21 and the flat surface 44 and the right-side pin 22 in a state of being arranged in the counterclockwise direction and sandwiched between the outer case 21 and the flat surface 44 is referred to as an initial position of the hook 33.

In the initial position of the hook 33, an intermediate point in the circumferential direction is referred to as an intermediate part of the initial position in the circumferential direction.

As the hooks 33 are integrally formed with the input member 30, the hooks 33 move in the clockwise direction or the counterclockwise direction when the input member 30 rotates.

Specifically, when the input member 30 rotationally moves in the clockwise direction, the hook 33 moves in the clockwise direction and abuts on the left-side pin 23 arranged in the clockwise direction. Then, when the hook 33 further moves in the clockwise direction, in other words, when the hook 33 moves beyond the initial position of the hook 33, the hook 33 presses the left-side pins 23 in the clockwise direction against the biasing force of the elastic body 24 (see FIGS. 8B and 8C). Accordingly, the left-side pin 23 sandwiched between the left end portion 44c of the flat surface 44 and the inner peripheral surface 21a moves toward the central portion 44a of the flat surface 44, and the disabled state of the rotational motion of the lock portion 43 (output member 40) in the clockwise direction is cancelled (see FIGS. 8B and 8C).

The right-side pin 22 not pressed by the hook 33 is maintained to be sandwiched between the right end portion 44b of the flat surface 44 and the inner peripheral surface 21a (see FIGS. 8B and 8C), therefore, the disabled state of the rotational motion of the lock portion 43 (output member 40) in the counterclockwise direction is also maintained.

The hooks 33 are apart from one another in the circumferential direction with respect to the left-side pins 23 arranged in the clockwise direction and the right-side pins 22 arranged in the counterclockwise direction when being positioned in the intermediate part of the initial position in the circumferential direction, which form gaps S1. Accordingly, even when the hook 33 (input member 30) vibrates (moves) in the circumferential direction due to the vibration during travelling, the disabled state of the rotational motion of the lock portion 43 (output member 40) is not cancelled.

In the embodiment, a rotation angle of the input member 30 which is necessary until the hook 33 positioned in the intermediate part of the initial position in the circumferential direction moves in the circumferential direction and presses the left-side pin 23 or the right-side pin 22 to cancel the disabled state of the rotational motion of the lock portion 43 is set to θ1 (refer to FIG. 6).

The transmission portions 34 are portions moving in the circumferential direction by the rotation of the input member 30 to press the transmitted portion 41 of the output member 40 in the circumferential direction.

As shown in FIG. 2, the transmission portions 34, 34 are provided by being shifted by 180 degrees in the inner peripheral side of the fixing portion 31, which face each other.

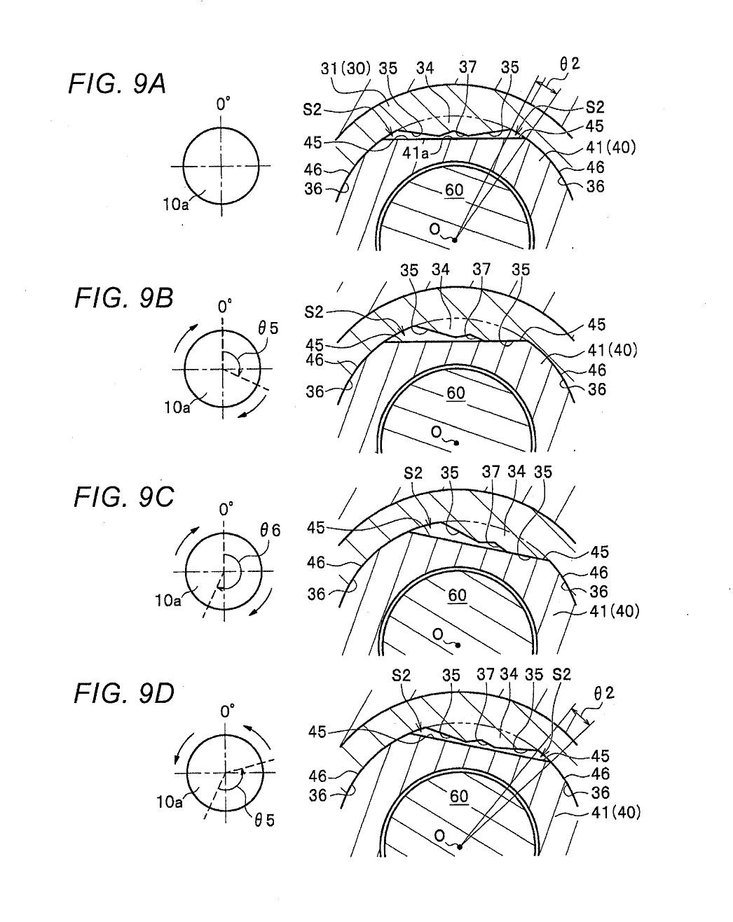

On the other hand, as shown in FIG. 9A, a flat surface 41a is formed at a portion facing the transmission portion 34 on the outer peripheral surface of the transmitted portion 41.

An arc-shaped outer peripheral arc surface 46 abutting on an inner peripheral arc surface 36 of the fixing portion 31 is formed at a portion not facing the transmission portion 34 on the outer peripheral surface of the transmitted portion 41.

In both end sides on the inner peripheral surface of the transmission portion 34, pressing surfaces 35, 35 pressing pressed surfaces 45 in both end sides of the flat surface 41a are formed. Each pressing surface 35 inclines so as to approach the flat surface 41a from the inner peripheral arc surface 36 of the fixing portion 31 toward the central portion.

Accordingly, when the input member 30 rotates, the pressing surface 35 makes a surface contact with the pressed surface 45 as shown in FIG. 9B.

When the input member 30 further rotates in the state where the pressing surface 35 makes a surface contact with the pressed surface 45, the pressing surface 35 presses the pressed surface 45 in the circumferential direction. Accordingly, the transmitted portion 41 rotates, and the drive force of the motor 10 is transmitted to the output member 40 as shown in FIG. 9C.

Note that a concave surface 37 concaved so as to be separated from the flat surface 41 toward the central portion is formed between the pressing surfaces 35, 35 on the inner peripheral surface of the transmitting portion 31, which prevents portions other than the pressing surfaces 35 from contacting the flat surface 41a as shown in FIG. 9A.

As shown in FIG. 9A, the pressing surfaces 35 are separated from the pressed surfaces 45 in the state where the drive force of the motor 10 is not transmitted to the input member 30, and gaps S2 are formed between the pressing surfaces 35 and the pressed surfaces 45.

A rotation angle of the input member 30 which is necessary until the pressed surface 35 moves in the gap S2 and abuts on (presses) the pressed surface 45 is set to θ2.

The rotation angle θ2 is set to be larger than the rotation angle θ1 of the input member 30 which is necessary until the disabled state of the rotational motion of the lock portion 43 is cancelled (θ2>θ1).

Next, the relation between the cylindrical portion 32 of the input member 30 and the shaft support portion 42 of the output member 40 will be explained.

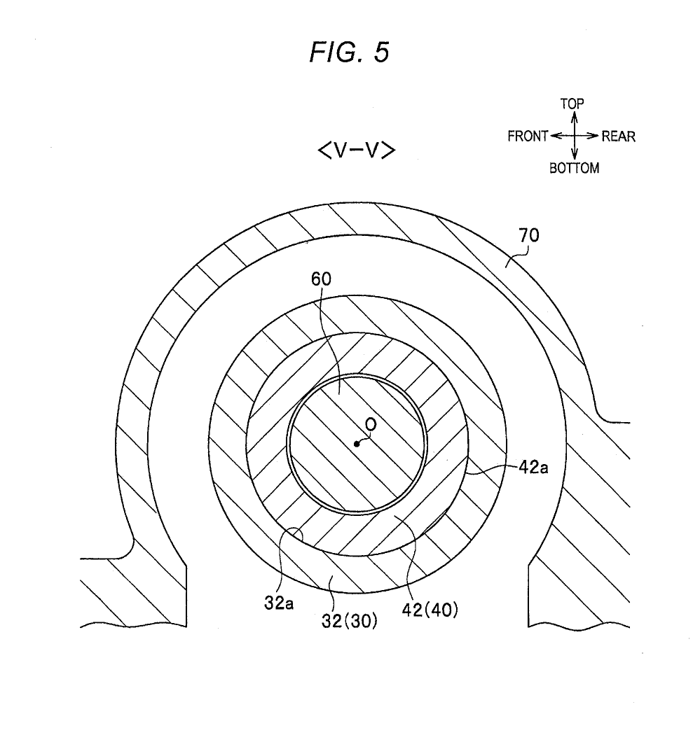

As shown in FIG. 5, the cylindrical portion 32 has a cylindrical shape, including an inner peripheral surface 32a having an approximately circular shape. An outer peripheral surface 42a of the shaft support portion 42 has an approximately circular shape, and an inner diameter of the cylindrical portion 32 and an outer diameter of the shaft support portion 42 are formed to have approximately the same diameter. Therefore, the input member 30 is supported by the output member 40 so as to rotationally move in a state where the rotation axes of the input member 30 and the output member 40 are the same.

Then, when the drive force of the motor 10 is transmitted to the worm wheel 12 and the input member 30 and is not transmitted to the output member 40, the worm wheel 12 and the input member 30 rotationally move around the output member 40 while the inner peripheral surface 32a of the cylindrical portion 32 slides on the outer peripheral surface 42a of the shaft support portion 42.

Here, though the cylindrical portion 32 slides on the outer peripheral surface 42a of the shaft support portion 42, the output member 40 does not rotate as the lock portion 43 is not able to rotate due to the pair of pins 22 and 23 as described later.

When the drive force of the motor 10 is transmitted to the output member 40, namely, when the disabled state of the rotation of the output member 40 is cancelled and the pressing surface 35 of the transmitting portion 34 presses the pressed surface 45 of the transmitted portion 41, the worm wheel 12, the input member 30, the output member 40 and the nut 51 rotate around the central axis O of the rod 60.

As shown in FIGS. 9A to 9D, the inner peripheral arc surfaces 36, 36 of the fixing portion 31 and the outer peripheral arc surfaces 46, 46 of the transmitted portion 41 are also formed to have approximately the same diameter. Accordingly, the inner peripheral arc surfaces 36, 36 slide on the outer peripheral arc surfaces 46, 46, and the transmitted portion 41 of the output member 40 has a function of pivotally supporting the input member 30 when the input member 30 rotationally moves.

Next, the attachment portion 80 will be explained with reference to FIG. 4.

The attachment portion 80 includes a lock nut 81 screwed to screw grooves formed on the outer peripheral surface of the output member 40, a spring seat 82 provided on the outer side of the lock nut 81 in the vehicle width direction and biasing the input member 30 to the outer side of the vehicle width direction, a waved washer 83 arranged on the inner peripheral side of the spring seat 82, a first washer 84 arranged between the spring seat 82 and the fixing portion 31 of the input member 30 and a second washer 85 arranged between the cylindrical portion 32 of the input member 30 and the lock portion 43 of the output member 40.

According to the above structure, the input member 30 is attached to the output member 40 in a state where the input member 30 does not move in the axial direction of the output member 40 as well as the relative rotational motion between the input member 30 and the output member 40 is allowed as the input member 30 is biased by the spring sheet 82 and the wave washer 83.

As the first washer 84 and the second washer 85 are interposed, the input member 30 and the output member 40 can relatively rotate easily.

As shown in FIG. 3, the stroke sensor 90 is a sensor for detecting the position of the rod 60, for measuring the moving distance of the rod 60 and for other purposes, including a bar-shaped detected portion 91 and a detection portion 92 detecting the length of the detected portion 91 entering the inside.

The stroke sensor 90 also transmits the measured results (the position and the moving distance of the rod 60) to the controller 100.

When the controller 100 is configured to measure the moving distance and so on of the rod 60 from the rotation angle of the rotation shaft 10a measured by the angle sensor 15, the moving distance of the rod 60 corresponding to the rotation of the rotation shaft 10a may differ from the initial state due to abrasion of respective parts. Accordingly, the stroke sensor 90 is provided in the present embodiment, thereby accurately grasping the position and the moving distance of the rod 60.

The controller 100 is a control device for adjusting the steering angle of the rear wheel 400 by controlling the motor 10. The controller 100 includes a CPU, a ROM, a RAM, various types of interfaces, an electronic circuit and so on, executing respective processing in accordance with programs stored thereinside.

The controller 100 stores a correlation chart (not shown) indicating the relation between the position of the rod 60 and the steering angle of the rear wheel 400. Accordingly, the controller 100 calculates the steering angle of the rear wheel 400 based on the correlation chart and the measured value (the position of the rod 60) transmitted from the stroke sensor 90.

The controller 100 also determines whether the steering angle of the rear wheel 400 is changed or not for increasing rotationality and vehicle stability and the like based on the steering angle and the vehicle velocity. Here, a method of determining whether the steering angle is changed or not is not particularly limited, and a known method can be appropriately used.

Then, when it is determined that the steering angle of the rear wheel 400 is changed (“START”), the controller 100 executes steering-angle change processing for controlling the steering angle of the rear wheel 400 so as to correspond to the travelling state.

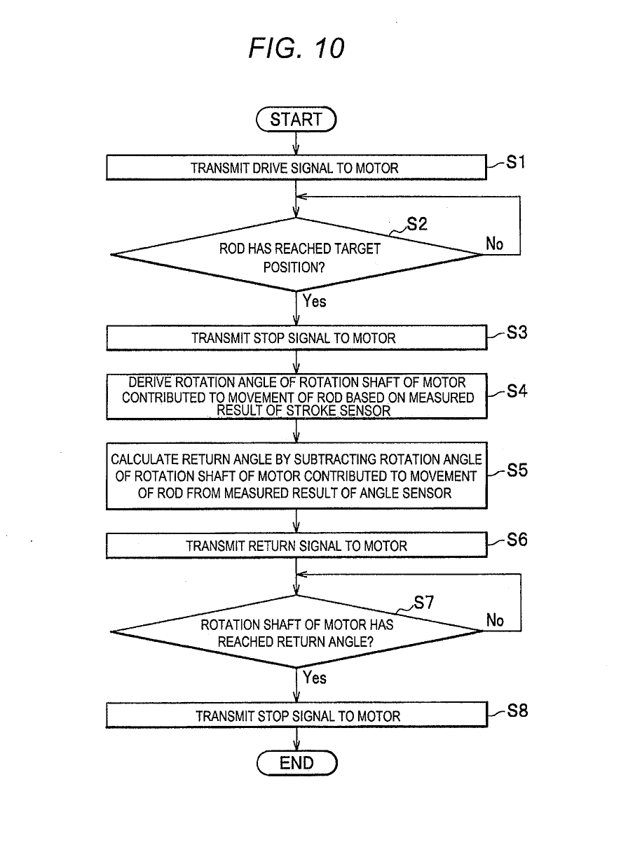

Hereinafter, the steering-angle change processing will be explained mainly with reference to FIG. 10. In the following explanation, the rotation direction of the rotation shaft 10a of the motor 10 will be explained based on FIGS. 9A to 9D.

In Step S1, the controller 100 sets a target position of the rod 60 and transmits a drive signal to the motor 10 so that the rod 60 moves to the target position.

Here, the above drive signal is a signal for instructing the motor 10 to rotate the rotation shaft 10a, and the rotation direction of the rotation shaft 10a is designated. In the embodiment, the rotation direction of the rotation shaft 10a by the drive signal is designated as the clockwise direction (see FIGS. 9A to 9C).

Accordingly, the motor 10 receiving the drive signal starts to rotate (one-direction rotation) of the rotation shaft 10a in the clockwise direction as shown in FIGS. 9A and 9B.

When the rotation angle of the rotation shaft 10a reaches θ5, the rotation angle of the input member 30 in the clockwise direction is θ2 and the pressing surface 35 abuts on the pressed surface 45 (see FIG. 9B).

Further, when the rotation angle of the rotation shaft 10a exceeds θ5, the pressing surface 35 starts to press the pressed surface 45, therefore, the output member 40 rotates (see FIG. 9C) and the rod 60 moves.

When the pressed surface 45 is pressed by the pressing surface 35, the input member 30 relatively rotates larger than the output member 4 by θ2.

In Step S2, the controller 100 determines whether the rod 60 has reached the target position or not based on the measured result (the position of the rod 60) transmitted from the stroke sensor 90. When it is determined that the rod 60 has not reached the target position, the controller 100 repeats the processing of Step S2. On the other hand, when it is determined that the rod 60 has reached the target position, the controller 100 proceeds to Step S3.

In Step S3, the controller 10 transmits a stop signal to the motor 10. Accordingly, the one-direction rotation of the rotation shaft 10a by the motor 10 is stopped. The rotation angle of the rotation shaft 10a of the motor 10 rotated until the rod 60 reaches the target position is θ6.

When the rotation shaft 10a of the motor 10 is stopped, the hook 33 presses the left-side pin 23 and the disabled state of the output member 40 in the clockwise direction is cancelled as shown in FIG. 8C.

In Step S4, the controller 100 calculates a rotation angle of the rotation shaft 10a of the motor 10 contributed to the movement of the rod 60 based on the measured result (the moving distance of the rod 60) transmitted from the stroke sensor 90.

The “rotation angle of the rotation shaft 10a of the motor 10 contributed to the movement of the rod 60” indicates an angle θ7 obtained when the rotation shaft 10a of the motor 10 is rotated during a period from the time when the pressing surface 35 abuts on (presses) the pressed surface 45 until the rod 60 reaches the target position.

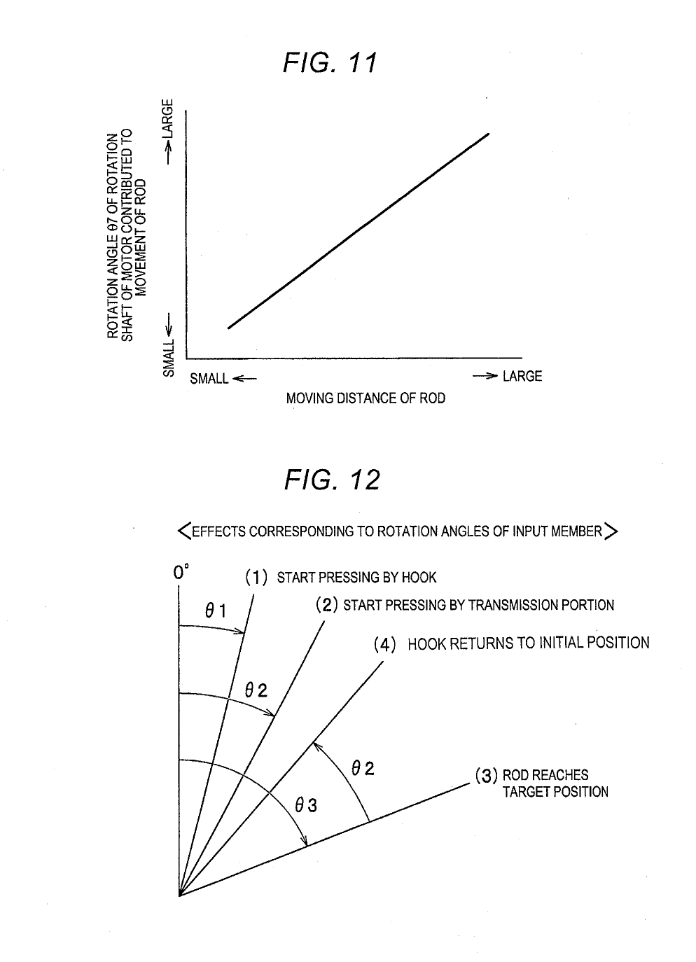

Here, the controller 100 stores the correlation chart indicating the relation between the moving distance of the rod 60 and the rotation angle θ7 of the rotation shaft 10a of the motor 10 contributed to the movement of the rod 60 as shown in FIG. 11. Accordingly, the controller 100 calculates the rotation angle θ7 of the rotation shaft 10a of the motor 10 contributed to the movement of the rod 60 by the correlation chart and the calculated moving distance of the rod 60.

The relation between the moving distance of the rod 60 and the rotation angle of the rotation shaft 10 of the motor 10 contributed to the movement of the rod 60 is a proportionality relation in which the rotation angle θ7 of the rotation shaft 10a of the motor 10 contributed to the movement of the rod 60 is increased as the moving distance of the rod 60 is increased.

In Step S5, the controller 100 calculates a rotation angle (hereinafter referred to as a “return angle”) of the rotation shaft 10a of the motor 10 for returning the plural hooks 33 to the initial position by subtracting the rotation angle θ7 of the rotation shaft 10a of the motor 10 contributed to the movement of the rod 60 from the measured result (the rotation angle θ6 of the rotation shaft 10a) transmitted from the angle sensor 15.

According to the above, the rotation angle of the rotation shaft 10a of the motor 10 not contributed to the movement of the movement of the rod 60, namely, the rotation angle θ5 of the rotation shaft 10a of the motor 10 contributed to the angle θ2 obtained by relative rotation of the input member 30 with respect to the output member 40 can be calculated.

In Step S6, the controller 100 transmits a return signal to the motor 10. The return signal is a signal designated so as to rotate (the other direction rotation) to the opposite side of the rotation direction designated by the drive signal. Accordingly, the rotation shaft 10a of the motor 10 starts to rotationally move in a direction (the counterclockwise direction in FIGS. 9A to 9D) different from the case of moving the rod 60 to the target position.

In Step S7, the controller 100 determines whether the rotation angle of the rotation shaft 10a of the motor 10 has reached the return angle θ5 or not based on the measured result (the rotation angle of the rotation shaft 10a) transmitted from the angle sensor 15.

Here, it is determined that the rod 60 has not reached the return angle θ5, the controller 100 repeats the processing of Step S7. On the other hand, it is determined that the rod 60 has reached the return angle θ5, the controller 100 proceeds to Step S8.

In Step S8, the controller 100 transmits the stop signal to the motor 10 and ends the steering-angle change processing (“END”).

Next, rotation angles of the input member 30 in the steering-angle change processing and effects of respective rotation angles will be explained mainly with reference to FIG. 12.

(1) When the rotation angle of the input member 30 in the clockwise direction reaches θ1, the pressing of the left-side pin 23 by the hook 33 is started, which enables the rotation of the output member 40 in the clockwise direction (see FIG. 8B).
(2) When the rotation angle of the input member 30 in the clockwise direction reaches θ2, the pressing of the transmitted surface 45 by the pressing surface 35 is started (see FIG. 9B). Accordingly, the rotation in the clockwise direction by the output member 40 is started (see FIG. 8C and FIG. 9C), and the rod 60 moves.
(3) When the rotation angle of the input member 30 in the clockwise direction reaches θ3 (when the one-direction rotation of the rotation shaft 10a by the motor 10 is stopped), the rod 60 reaches the target position and the steering angle of the rear wheel 40 becomes a desired angle.
(4) After the rod 60 reaches the target position, the input member 30 rotates in the counterclockwise direction. Here, as the rotation angle of the other direction rotation of the rotation shaft 10a by the motor 10 is θ5, the input member 30 rotates in the counterclockwise direction by θ2.

Accordingly, the input member 30 relatively rotates with respect to the output member 40 by θ2, and the hook 33 of the input member 30 returns to the initial position and is positioned at the intermediate part of the initial position in the circumferential direction (see FIG. 8D).

The transmission portion 34 of the input member 30 also moves in the counterclockwise direction and the rotation angle of the input member 30 which is necessary until the pressing surface 35 abuts on (presses) the pressed surface 45 is θ2 (see FIG. 9D).

According to the embodiment described above, after the rod 60 reaches the target position, the hook 33 returns to the initial position and the pressing of the left-side pin 23 by the hook 33 is cancelled. Then, the left-side pin 23 is pressed by the biasing force of the elastic body 24 (see an arrow F of FIG. 8D), and is sandwiched between the inner peripheral 21a of the outer case 21 and the left end portion 44c of the flat surface 44. Accordingly, the output member 40 is in the disabled state of the rotational motion, which prevents backlash of the rod 60.

As the angle sensor 15 and the stroke sensor 90 are provided in the embodiment, the rotation angle of the rotation shaft 10a of the motor 10 and the moving distance of the rod 60 can be accurately measured. Accordingly, the return angle calculated from the accurate rotation angle of the rotation shaft 10a of the motor 10 and the accurate moving distance of the rod 60 can be grasped accurately, and the hook 33 can be returned to the intermediate part of the initial position in the circumferential direction positively.

As the nut 51 rotatably supported by the ball bearing 54 and the roller bearing 55 and the output member 40 are integrally formed in the embodiment, the bearing supporting the output member 40 by itself so as to rotate is not necessary, which reduces the number of parts.

As the input member 30 and the worm wheel 12 are integrally formed, the bearing rotatably supporting the worm wheel 12 by itself is not necessary.

The embodiment has been explained as the above, and the present invention is not limited to examples explained in the embodiment.

For example, it is also preferable that the actuator 1 does not include the angle sensor 15 and the stroke sensor 90, and the rotation angle (return angle) of the rotation shaft 10a of the motor 10 for returning the plural hooks 33 to the initial position may be set to a predetermined angle. According to the structure, the sensor is not necessary and the size of actuator 1 can be reduced.

The predetermined angle may be set to the rotation angle θ5 of the rotation shaft 10a of the motor 10 which is necessary for setting the angle at which the input member 30 relatively rotates with respect to the output member 40 to θ2, or an angle obtained in consideration of abrasion resistance receiving by the rotation shaft 10a from the bearing 13a and the biasing force of the elastic body 24 received by the hooks 33 with respect to the angle θ5.

In the actuator 1, when the worm gear 11 and the worm wheel 12 are worn down, the rotation angle of the input member 30 corresponding to the rotation angle of the rotation shaft 10a of the motor 10 is reduced.

That is, when the input member 30 is rotated by a given angle, there is a feature that the rotation angle of the rotation shaft 10a of the motor 10 is increased as the parts are worn down severely.

Accordingly, in the initial state of the actuator 1, an angle larger than θ5 as the rotation angle of the rotation shaft 10a which is necessary for returning the hooks 33 to the initial position is set as an allowable angle. Then, the controller 100 may be configured to determine whether the calculated rotation angle (return angle) of the rotation shaft 10a of the motor 10 for returning the plural hooks 33 to the initial position is within the allowable angle or not. According to the structure, it is possible to determine whether parts exchange and the like is necessary or not without disassembling the actuator 1.

Furthermore, when it is determined that the calculated return angle exceeds the allowable angle, the controller 100 may transmit a warning signal to a control device (not shown) of the vehicle or an alarm device may be provided in the actuator 1 to inform the user by the alarm device.

The reverse input prevention device 20 according to the embodiment includes the outer case 21 as the circular inner peripheral surface 21a facing the flat surfaces 44 of the lock portion 43 of the output member 40, and it is also preferable that the circular inner peripheral surface 21a is formed on an inner peripheral surface of the housing 70. According to the structure, the outer case 21 is not necessary.

Furthermore, the transmission portions 34 moving in the circumferential direction by the rotational motion of the input member 30 are formed on the inner peripheral surface of the fixing portion 31 of the input member 30, and the transmitted portion 41 extending from the shaft support portion 42 to the inside of the vehicle width direction and positioned on tracks of the transmitted portions 34 is formed in the embodiment. The present invention is not limited to this as long as the drive force of the motor 10 can be transmitted from the input member to the output member 40.

Though the ball screw is used as the conversion device 50 in the embodiment, it is also preferable to use a feed screw in the present invention.

In the embodiment, the worm gear 11 and the worm wheel 12 are used as members for transmitting the drive force of the motor 10 to the input member 30, however, it is also preferable to use a belt and a pulley in the present invention instead of the worm gear 11 and the worm wheel 12. It is further preferable to use a bevel gear to transmit the drive force of the motor 10 to the input member 30, or it is preferable that the direction of the rotation shaft 10a of the motor 10 is allowed to be the same direction as the input member 30 to transmit the drive force of the motor 10 to the input member 30 by a spur gear.

What is claimed is:

1. An actuator comprising:
a motor comprising a rotation shaft;
a reverse input prevention device comprising an input member which is rotated by rotation of the rotation shaft and an output member which is rotated by rotation of the input member, preventing an external force inputted to the output member from being transmitted to the input member;
a conversion device that converts a rotational motion of the output member into a linear motion; and
a rod advancing/retracting by the linear motion of the conversion device,
wherein the reverse input prevention device comprises
the output member having a lock portion in which plural flat surfaces are formed on an outer peripheral surface,
an outer peripheral wall portion in which an approximately circular inner peripheral surface surrounding an outer periphery of the lock portion is formed,
pairs of pins arranged between the respective flat surfaces and the inner peripheral surface,
elastic bodies arranged between the pairs of pins and each biasing a corresponding one of the pairs of pins so that the pins of the corresponding pair are apart from one another in a circumferential direction, and
the input member comprising plural hooks arranged on both sides of the pairs of pins in the circumferential direction, and
after the rod reaches a target position by one-direction rotation of the rotation shaft, the plural hooks return to a initial position relative to the pairs of pins by the other-direction rotation of the rotation shaft.

2. The actuator according to claim 1, further comprising:
a controller controlling the motor;
an angle sensor measuring a rotation angle of the rotation shaft of the motor; and
a stroke sensor measuring a moving distance of the rod,
wherein the controller calculates a rotation angle of the rotation shaft of the motor contributed to the movement of the rod from the moving distance measured by the stroke sensor, and calculates a rotation angle of the rotation shaft of the motor for returning the plural hooks to the initial position by subtracting the rotation angle of the rotation shaft of the motor contributed to the movement of the rod from the rotation angle measured by the angle sensor.

3. The actuator according to claim 2,
wherein the controller determines whether the rotation angle of the rotation shaft of the motor for returning the plural hooks to the initial position is within an allowable angle or not.

4. The actuator according to claim 1,
wherein the rotation angle of the rotation shaft of the motor for returning the plural hooks to the initial position is set to a predetermined angle.

5. The actuator according to claim 1, further comprising:
a worm gear connecting to the rotation shaft;
a worm wheel engaged with the worm gear,
wherein the conversion device comprises a nut rotating by the rotation of the output member,
the input member and the worm wheel are integrally formed, and the output member and the nut are integrally formed.

6. The actuator according to claim 2, further comprising:
a worm gear connecting to the rotation shaft;
a worm wheel engaged with the worm gear,
wherein the conversion device comprises a nut rotating by the rotation of the output member,
the input member and the worm wheel are integrally formed, and
the output member and the nut are integrally formed.

7. The actuator according to claim 3, further comprising:
a worm gear connecting to the rotation shaft;
a worm wheel engaged with the worm gear,
wherein the conversion device comprises a nut rotating by the rotation of the output member,
the input member and the worm wheel are integrally formed, and
the output member and the nut are integrally formed.

8. The actuator according to claim 4, further comprising:
a worm gear connecting to the rotation shaft;
a worm wheel engaged with the worm gear,
wherein the conversion device comprises a nut rotating by the rotation of the output member,
the input member and the worm wheel are integrally formed, and
the output member and the nut are integrally formed.

9. A vehicle steering apparatus comprising;
an actuator comprising an advancing/retracting rod, which steers vehicle wheels by advancing/retracting the rod,
wherein the actuator comprises:
a motor comprising a rotation shaft;
a reverse input prevention device comprising an input member which is rotated by rotation of the rotation shaft and an output member which is rotated by rotation of the input member, preventing an external force inputted to the output member from being transmitted to the input member;
a conversion device that converts a rotational motion of the output member into a linear motion; and
the rod advancing/retracting by the linear motion of the conversion device,
wherein the reverse input prevention device comprises
the output member having a lock portion in which plural flat surfaces are formed on an outer peripheral surface,
an outer peripheral wall portion in which an approximately circular inner peripheral surface surrounding an outer periphery of the lock portion is formed,
pairs of pins arranged between the respective flat surfaces and the inner peripheral surface,
elastic bodies arranged between the pairs of pins and each biasing a corresponding one of the pairs of pins so that the pins of the corresponding pair are apart from one another in a circumferential direction, and
the input member comprising plural hooks arranged on both sides of the pairs of pins in the circumferential direction, and
after the rod reaches a target position by one-direction rotation of the rotation shaft, the plural hooks return to an initial position relative to the pairs of pins by the other-direction rotation of the rotation shaft.
